(19) United States
(12) Patent Application Publication
(10) Pub. No.: US 2019/0007811 A1
(43) Pub. Date: Jan. 3, 2019

(54) RECONFIGURABLE MOBILE DEVICE USING UNIFIED RADIO APPLICATION INTERFACE, AND OPERATION METHOD THEREOF

(71) Applicant: INDUSTRY-UNIVERSTY COOPERATION FOUNDATION HANYANG UNIVERSITY, Seoul (KR)

(72) Inventors: Seung Won CHOI, Seoul (KR); Kyung Hoon KIM, Seoul (KR); Dong Hyun KUEM, Gyeonggi-do (KR); Yong JIN, Seoul (KR)

(73) Assignee: INDUSTRY-UNIVERSTY COOPERATION FOUNDATION HANYANG UNIVERSITY, Seoul (KR)

(21) Appl. No.: 15/752,353

(22) PCT Filed: Aug. 17, 2016
(86) PCT No.: PCT/KR2016/009006

§ 371 Date: Feb. 13, 2018

(30) Foreign Application Priority Data
Aug. 18, 2015 (KR) 10-2015-0115901
Nov. 27, 2015 (KR) 10-2015-0167834
Aug. 16, 2016 (KR) 10-2016-0103581

(51) Int. Cl. H04W 4/50; H04B 1/00

(52) U.S. Cl. CPC H04W 4/50; H04W 88/06; H04B 1/0003

(57) ABSTRACT

A unified radio application interface and a reconfigurable mobile device utilizing the same are disclosed. The unified radio application interface, which is one of interfaces mounted on the reconfigurable mobile device, comprises: a first module for a radio application management service; a second module for a user data flow service; and a third module for a multi-radio control service, wherein the unified radio application interface provides at least one of a radio application management service, a user data flow service, and a multi-radio control service to a radio control framework (RCF) operating on a radio computer of a mobile device and to an unified radio application (URA) operating on a radio computer, and supports the RCF so as to reconfigure a radio application according to a wireless communication environment or a wireless connection environment of the mobile device.

### TECHNICAL FIELD

The present invention relates to a reconfigurable mobile device using a unified radio application interface for a radio application that generates a transmission radio signal or decodes a reception radio frequency (RF) signal at the mobile device and an operation method thereof.

### BACKGROUND ART

As communication technology advances, various new kinds of radio applications are being used as adapted for tastes and objectives of users. The most of radio applications, such as a Long Term Evolution (LTE), a Wide-band Code Division Multiple Access (WCDMA), a Worldwide Interoperability for Microwave Access (WiMAX), a Global System for Mobile Communications (GSM), may operate on radio terminals by interworking with a modem embedded in the radio terminal.

In order to make it possible that a radio application controls the modem, a customized module should be developed based on understanding unique instructions of each modem designed by various modem manufactures or having various models. This situation leads to a result that a specific application can be executed on a specific modem designed by a specific manufacturer, or even on a specific model of modem designed by the specific manufacturer. To overcome the above-mentioned problem, different control instruction codes customized for various kinds of modems should be comprised in the radio application, or different executable file for each modem should be built and distributed.

However, since it is practically impossible to optimize the radio application to all the various kinds of modem hardware currently available in the market currently by the above-mentioned methods, there is a problem that a great manpower is needed to develop a radio application.

In order to resolve the above-described problems, there were attempts to produce hardware-independent multi radio applications by using unified instruction sets instead of instruction sets unique for respective manufacturers.

Also, a technology which can convert a manner in which each of a radio base station and a terminal apparatus supports radio frequency (RF) through hardware into a manner in which each of the radio base station and the terminal apparatus supports RF through software. That is, a software defined radio (SDR) technology can make it possible that a single apparatus can support multiple modes, multiples bands, and multiple environments without being restricted to a specific location or time.

If a SDR module is installed in a portable terminal such as a mobile phone, a personal digital assistant (PDA), and a laptop computer, the SDR module can make it possible that the terminal supports different frequency bands and two or more systems. That is, the SDR technology can provide a new communication manner for various wireless networks, various wireless communication systems, various frequency bands, and high-speed data communications in a fourth generation communication pursuing an all internet protocol (All-IP) based wireless multimedia communications.

In connection with the software defined radio (SDR) technology, there exists a software communication architecture (SCA) which is a defacto standard technology. It may comprise specifications related to frameworks for SDR, middleware, and real-time operating system (OS), which guarantees compatibility of interfaces between SDR systems. The core of SCA is a core framework which is a framework specification. In the core framework, various parts constituting radio applications are componentized and the components may be reused and assembled so as to create a new radio application.

In case of SCA, it is possible to make rearrangement of blocks which are already installed in a terminal. However, user-defined blocks to be used for a specific radio application cannot be installed even into SCA compatible terminals having different hardware configurations. Thus, single executable codes cannot be used for all SCA compatible terminals.

This means that executable codes optimized for each hardware configuration on which each SCA compatible terminal is based should be respectively created and distributed. This demands very much time and cost, and makes commercial uses of radio applications difficult. Also, it does not provide baseband application programming interface (API) for implementation of radio applications, and accordingly it makes selective utilization of hardware acceleration functions difficult.

Meanwhile, a software defined radio (SDR) technology is a technology for allowing global communications by downloading object-oriented structure application software onto an open architecture single hardware platform to construct a system that can flexibly adapt to various radio access environments. The SDR technology reduces fixed hardware functions in a user's mobile device from a signal processing perspective, extends a portion of programmable hardware by a radio application, and increases flexibility of the system by utilizing extended software capabilities.

However, such the structure of the SDR terminal (terminal device) should have openness, dispersibility, object orientation, and software controllability. In particular, a multimode SDR capable of accommodating various radio standards is required for the global communications. In this atmosphere, researches on the multimode SDR that can be practically commercialized are being actively carried out.

### DISCLOSURE

### Technical Problem

The purpose of the present invention is to provide a reconfigurable mobile device using a unified radio application interface for interfacing between a radio application that generates a transmission radio signal or decodes a reception radio frequency (RF) signal at the mobile device, and a radio control framework that manages the radio application.

Another purpose of the present invention is to provide an operation method of a reconfigurable mobile device capable of controlling operations of multiple radio applications by using a unified radio application interface or changing a combination of the radio applications in operation according to surrounding environments such as radio environments.

### Technical Solution

In an aspect of the present invention to achieve the above-described objective, an operation method of a reconfigurable mobile device using a unified radio application interface (URAI) may comprise providing a radio control framework (RCF) operating on a radio computer of the mobile device and a unified radio application (URA) operating on the radio computer with at least one service among radio application management services, user data flow services, and multiradio control services of the URAI; and communicating, by the RCF, with the URA through the URAI, and reconfiguring a radio application according to a radio communication environment or a radio access environment of the mobile device.

At least one module for at least one service among the radio application management services, the user data flow services, and the multiradio control services may be stored in a memory of the mobile device, and loaded to the radio control framework as being executed by the radio computer or a radio operation system.

Here, the radio application management services may include, from the RCF to the URA, a service of requesting report of discovered peer equipment, a service of requesting creation or termination of association with the peer equipment, a service of requesting start or stop of communications with the peer equipment, or a service of a combination thereof.

Here, the radio application management services may include, from the URA to the RCF, a service of confirming the creation of association with the peer equipment, a service of confirming the termination of association with the peer equipment, a service of confirming the start of communications with the peer equipment, a service of confirming the stop of communications with the peer equipment, a service of notifying a failure of the creation of association with the peer equipment, a service of notifying a failure of the termination of association with the peer equipment, a service of notifying a failure of the start of communications with the peer equipment, a service of notifying a failure of the stop of communications with the peer equipment, a service of transmitting or receiving information, state information, or messages about the peer equipment, or a service of a combination thereof.

Here, the radio application management services may support a radio connection manager of the RCF to install a radio application and activate the installed radio application.

Here, the radio application management services may support the URA to inform the radio connection manager about accessible peer equipment discovered during a discovery procedure.

Here, the discovery of the peer equipment may be performed through the radio application management services by using an integrated circuit embodied in the mobile device.

Here, the user data flow services may support the RCF to request the URA to transfer user data.

Here, the user data flow services may include, from the URA to the RCF, a service of requesting to change data flow configuration, a service of transferring information related to the URA, a service of confirmation of transferring user data, a service of responding a failure of transferring user data a service of transmitting a confirmation message or a response to transferred user data, or a service of a combination thereof.

Here, the user data flow services may support the URA to request a flow controller of the RCF to change data flow configuration.

Here, the multiradio control services may support the RCF to request radio time synchronization to the URA.

Here, the multiradio control services may support the URA to transfer a message for confirming the radio time synchronization or notifying a failure of the radio time synchronization to the RCF.

In another aspect of the present invention to achieve the above-described objective, a reconfigurable mobile device may comprise a radio platform including a radio frequency (RF) transceiver as a part of hardware of the mobile device; a radio control framework (RCF) which is a part of a radio operating system operating on the radio platform; a unified radio application (URA) installed on the radio operating system and managed by the RCF; and a unified radio application interface (URAI) which provides, between the RCF and the URA, at least one service of radio application management services, user data flow services, and multiradio control services to the RCF and the URA.

Here, the URAI may provide, from the RCF to the URA through the radio application management services, a service of requesting report of discovered peer equipment, a service of requesting creation or termination of association with the peer equipment, a service of requesting start or stop of communications with the peer equipment, or a service of a combination thereof.

Here, the URAI may provide, from the URA to the RCF through the radio application management services, a service of confirming the creation of association with the peer equipment, a service of confirming the termination of association with the peer equipment, a service of confirming the start of communications with the peer equipment, a service of confirming the stop of communications with the peer equipment, a service of notifying a failure of the creation of association with the peer equipment, a service of notifying a failure of the termination of association with the peer equipment, a service of notifying a failure of the start of communications with the peer equipment, a service of notifying a failure of the stop of communications with the peer equipment, a service of transmitting or receiving information, state information, or messages about the peer equipment, or a service of a combination thereof.

Here, the URAI may support, through the radio application management services, a radio connection manager of the RCF to install a radio application in the radio operating system and activate the installed radio application.

Here, the URAI may support, through the radio application management services, the URA to inform the radio connection manager about accessible peer equipment discovered during a discovery procedure.

Here, the URAI may support, through the user data flow services, the RCF to request the URA to transfer user data.

Here, the URAI may provide, from the URA to the RCF through the user data flow services, a service of requesting to change data flow configuration, a service of transferring information related to the URA, confirmation of transferring user data, a service of responding a failure of transferring user data, a service of transmitting a confirmation message or a response to transferred user data or a service of a combination thereof.

Here, the URAI may support, through the user data flow services, the URA to request a flow controller of the RCF to change data flow configuration.

Here, the URAI may support the RCF to request radio time synchronization to the URA through the multiradio control services, and support the RCF to receive a message for confirming the radio time synchronization or notifying a failure of the radio time synchronization from the URA through the multiradio control services.

### Advantageous Effects

Using the above-described unified radio application interface (URAI) and the reconfigurable mobile device using the same according to the present invention, it is made possible that various radio applications can be installed and reconfigured independently of hardware platforms of mobile devices.

In addition, in aspect of mobile operators, it may become possible to switch radio access technologies of which terminals based on various radio platforms that subscribers are using into desired radio access technologies according to their needs so that flexible operation of mobile networks may be possible.

In addition, in aspect of subscribers, it may become possible that they can use new radio access technologies only by downing a radio application package for a desired radio application and installing the desired radio application in their terminals without purchasing new terminals. Accordingly, the cost of purchasing a new mobile terminal can be reduced, and a single mobile terminal can be used for various radio access technologies, thereby improving user convenience.

### DESCRIPTION OF DRAWINGS

FIG. 1 is a block diagram for explaining major components of a reconfigurable mobile device including a unified radio application interface (URAI) according to an embodiment of the present invention.

FIG. 2 is a UML class diagram for four major interfaces of the mobile device of FIG. 1.

FIG. 3 is a block diagram illustrating a structure for connecting the radio control framework (RCF) and the unified radio application (URA) using the URAI in the mobile device of FIG. 1.

FIG. 4 is a UML class diagram of a radio computer class associated with a URAI according to an embodiment of the present invention.

FIG. 5 is a UML diagram of three services applicable to the URAI of FIG. 4.

FIG. 6 is a block diagram for explaining a reconfigurable mobile device according to another embodiment of the present invention.

### BEST MODE

The present invention may be variously modified and may include various embodiments. However, particular embodiments are exemplarily illustrated in the drawings and will be described in detail. However, it should be understood that the particular embodiments are not intended to limit the present disclosure to specific forms, but rather the present disclosure is meant to cover all modification, similarities, and alternatives which are included in the spirit and scope of the present disclosure. Like reference numerals refer to like elements throughout the description of the drawings.

Relational terms such as first, second, A, B, and the like may be used for describing various elements, but the elements should not be limited by the terms. The terms are used solely for distinguishing one element from another. For instance, without departing the scope of the present disclosure, a first element may be named as a second element, and similarly, a second element may be named as a first element. The term “and/or” encompasses both combinations of the plurality of related items disclosed and any item from among the plurality of related items disclosed.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is not for delimiting the present invention but for describing the specific embodiments. The terms of a singular form may include plural forms unless otherwise specified. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. In describing the invention, to facilitate the entire understanding of the invention, like numbers refer to like elements throughout the description of the figures, and a repetitive description on the same element is not provided.

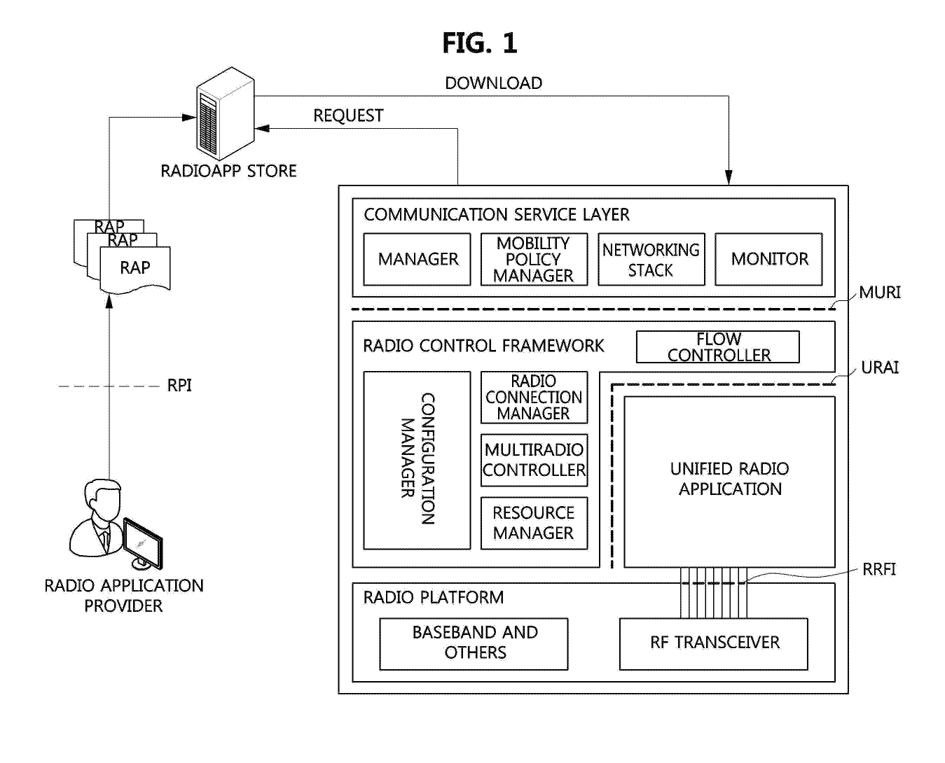

FIG. 1 is a block diagram illustrating major components of a reconfigurable mobile device including a unified radio application interface (URAI) according to an embodiment of the present invention.

Referring to FIG. 1, a reconfigurable mobile device (MD) according to an embodiment of the present invention may be capable of executing multiple radios simultaneously and of changing the setting of radios by loading new radio application packages (RAPs). A plurality of radio applications (RAs) may be called as unified radio applications (URAs) when they exhibit a common behavior from aspect of radio reconfiguration of the mobile device.

The radio application (RA) may refer to software that performs the generation of a transmission RF signal and the decoding of a reception RF signal. Such software may be executed in a particular radio platform or a radio virtual machine (RVM) that is part of a radio platform. Also, radio applications may be represented in different forms. That is, the radio applications may be expressed in a form of source codes, intermediate representations (IRs), and executable codes, and each of the source codes and the intermediate representations may include a radio library that invokes radio library native implementation calls and radio hardware abstraction layer (HAL) calls, and the executable code may be for a specific radio platform.

A radio application package (RAP) generated by a radio application provider via a radio programming interface (RPI) may be uploaded to a radio app store or the like, and upon receipt of a request from the reconfigurable mobile device, and the RAP may be downloaded to the mobile device via a predetermined link.

The link may refer to connecting a location to another location via a radio access technology (RAT) for the purpose of transmitting and receiving digital information. Here, each link is transmitted through a predetermined channel. A channel is a designated part of an information transmission capability having specific characteristics provided at a user network interface. Here, an over-the-air wireless propagation channel is used to carry information signals from a transmitter to a receiver.

A logical communication link to a wireless access network or peer equipment may be referred to as an association. In general, some control signaling is needed to maintain the association. User data transmission does not occur only in the associated state, but data flow may be established in the associated state for this purpose. Also, the peer equipment may be any communication computer component of the reconfigurable mobile device, and a logical communication link (i.e., association) between the reconfigurable MD and the peer equipment may be established.

In order to run multiple URAs in the above-described reconfigurable MD, the reconfigurable MD (hereinafter, referred to simply as ‘mobile device’) may include the CSL, RCF, radio platform and 4 sets of interfaces for their interconnection.

In the mobile device architecture, four sets of interfaces include a MUltiRadio Interface (MURI), a Reconfigurable Radio Frequency Interface (RRFI), a Unified Radio Application Interface (URAI), and a Radio Programming Interface (RPI).

The MURI is an interface between the communication service layer and the radio control framework. The RRFI is an interface between the unified radio application and an RF transceiver. The URAI is an interface between the unified radio application and the radio control framework. Also, the RPI is an interface for independent and uniform production of radio applications.

The mobile device described above is a mobile device with radio communication capability that supports radio reconfiguration. Here, the reconfigurable MD includes, but is not limited to, smartphones, feature phones, tablets, and laptops.

The communication services layer (CSL) is a layer related to generic applications that support communication services. Here, the communication service layer supports general applications such as Internet access. The communication service layer herein may include an administrator, a mobility policy manager (MPM), a networking stack, and a monitor.

The radio control framework (RCF) is a control framework that is part of the operating system that extends operating system capabilities in terms of radio resource management. Here, the radio control framework includes a configuration manager (CM), a radio connection manager (RCM), a flow controller (FC), a multiradio controller (MRC), and a resource manager (RM). The resource manager may be part of the operating system.

In other words, the radio control framework (RCF) is a component for providing operation environment of radio applications. The radio control framework basically manages each radio application using at least a part of the five components of the configuration manager, the radio connection manager, the flow controller, the multiradio controller, and the resource manager.

Configuration Manager (CM) may be responsible for installation/uninstallation and creating/deleting instance of RAs for a multi radio terminal apparatus which is the mobile device, and access management of radio parameters for RAs.

Radio Connection Manager (RCM) may be responsible for activation/deactivation of RAs according to user requests, and overall management of user data flows, which can also be switched from one RA to another.

Flow Controller (FC) may be responsible for transmitting and receiving of user data packets and controlling the flow of signaling packets.

Multiradio Controller (MRC) may be responsible for scheduling the requests for radio resources issued by concurrently executing RAs and detecting and managing the interoperability problems among the concurrently executing RAs.

Resource Manager (RM) may be responsible for managing multi-radio resources to share them among simultaneously active RAs, and to guarantee their real-time requirements. The resource manager may be part of the operating system.

Meanwhile, the RCF may comprise only some of the above-described 5 components, and may further comprise additional components as well as the above-described 5 components. Also, one or more components among the above-described components may be integrated into a single component existing within the RCF. The function and role of the RCF may be defined based on functions performed by the components which will be described. The above-described exemplary components do not restrict composition of the RCF. That is, the RCF may have various configurations for performing at least some of functions of the above-described components.

The radio platform may include hardware for implementation of function blocks as part of the hardware of the mobile device capable of generating a signal or receiving a high frequency signal. The hardware may be heterogeneous hardware, including different signal processing components such as fixed or dedicated accelerators and reconfigurable accelerators. The dedicated accelerator may include an application-specific integrated circuit (ASIC), and the reconfigurable accelerator may be a field programmable gate array (FPGA), a graphics processing unit (GPU), a digital signal processing device, and the like.

That is, the radio platform may include programmable hardware, dedicated hardware, an RF transceiver, and an antenna as part of the hardware of the mobile device associated with the radio signal processing capability. The programmable hardware and the dedicated hardware may be included in a modem, the modem may correspond to baseband and other components, and the dedicated hardware may include a hardware accelerator or a baseband accelerator. With programmable hardware, it is possible to support extendibility of standard function blocks in the reconfigurable mobile device.

The baseband accelerator, which is prepared for the execution of the function blocks, may often be provided in the form of an application-specific integrated circuit (ASIC). Such the radio platform may be connected to a unified radio application (URA) via a reconfigurable radio frequency interface (RRFI). The RRFI is an interface between the radio platform and the unified radio application.

The above-described radio platform may correspond to radio platform hardware, and may be connected to the radio operating system (OS) through the radio platform driver. Here, the radio control framework may operate on the radio OS and the communication service layer.

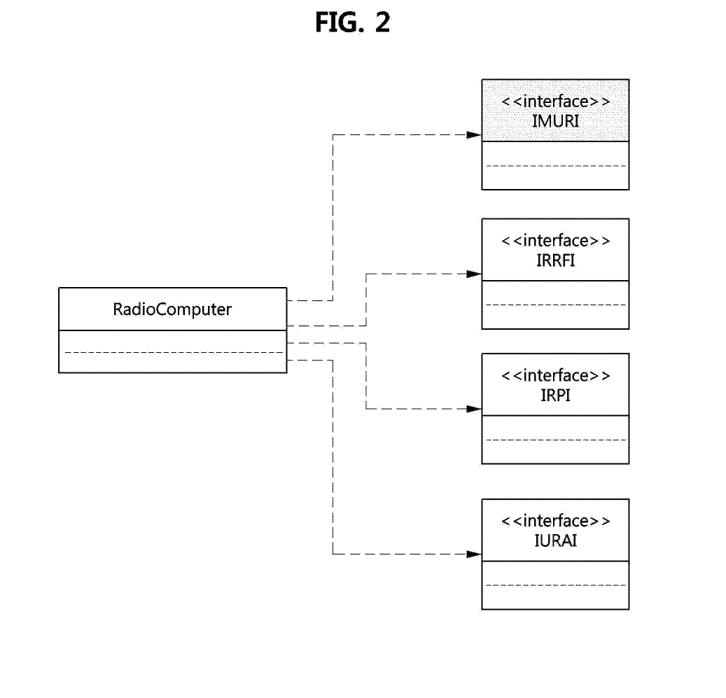

FIG. 2 is a UML class diagram for four major interfaces of the mobile device of FIG. 1.

Referring to FIG. 2, the mobile device according to the present embodiment may be illustrated as a radio computer when an individual unified radio application is designed as a predetermined software entity.

In the case described above, the radio computer has a UML class (IMURI) of a radio computer interface connected to the MURI, a UML class (IRRFI) of a radio computer interface connected to the RRFI, a UML class (IURAI) of a radio computer interface connected to the URAI, and a UML class (IRPI) of a radio computer interface associated with the user.

The Unified Modeling Language (UML) may be used to define information models and protocols related to the RRFI, the MURI, etc., but is not limited thereto, and other modeling languages may be used.

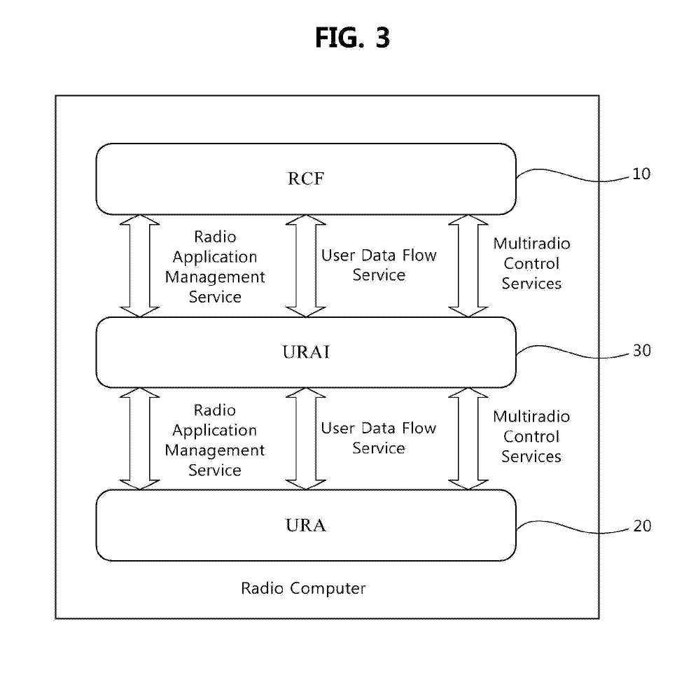

FIG. 3 is a block diagram illustrating a structure for connecting the radio control framework (RCF) and the unified radio application (URA) using the URAI in the mobile device of FIG. 1.

Referring to FIG. 3, the unified radio application interface (URAI) 30 according to the present embodiment may support the radio control framework (RCF) 10 operating on a radio computer and the unified radio application radio application, URA) 20 to communicate with each other.

The URAI 30 may support three services: radio application management services, user data flow services, and multiradio control services.

Also, the URAI may further support one or more services selected from resource management services, radio connection management services, parameter administration services, and the like according to its implementation.

The radio computer is a hardware part of the mobile device operating in the radio operating system (ROS), and may include, for example, the radio platform. The radio operating system may be loaded on the radio platform, and the radio platform driver may be installed between the radio platform and the radio operating system. Also, on the radio computer, more specifically, radio applications may be run on the radio operating system.

The radio operating system is a suitable real-time operating system that is authorized by the radio control framework to reconfigure the software architecture, install or run the function blocks, and the like. The radio operating system may provide basic management capabilities and radio control framework capabilities related to management of the radio platform such as resource management, file system support, and unified access to hardware resources. To this end, the radio computer may comprise the radio platform driver. The radio platform driver is a hardware driver for the radio operating system and can interact with the radio platform hardware.

In the present embodiment, the unified radio application interface may correspond to a method of configuring or reconfiguring a radio application between the RCF and the URA, each service supported by the unified radio application interface may correspond to respective steps of the method for configuring or reconfiguring the radio application between the RCF and the URA, and these steps may correspond to instructions, procedures, programs, modules, or combinations thereof stored in a memory or loaded into a process for execution of the respective steps.

URAI System Requirement Mapping

The above-described components of the radio computer may support URAI system requirements as the following tables 1 to 4.

TABLE 1

| Entity/Component/Unit | System Requirements | Comments |
|---|---|---|
| Configuration Manager | R-FUNC-RAT-01 | A reconfigurable MD should support |
| | | parallel connections to more than one radio |
| | | access technology. The requirement is |
| | | described in clause 6.1.1 of [1]. |
| | | ([1]: ETST EN 303 905) |
| | R-FUNC-RAT-06 | If a reconfigurable MD allows parallel |
| | | connections to RATs (in alignment to R- |
| | | FUNC-RAT-01). Link Adaptation |
| | | techniques across multiple RATs should be |
| | | implemented. The requirement is described |
| | | in clauses 6.1.6 of [1]. |
| | R-FUNC-RA-01 | Reconfigurable MDs shall support the |
| | | execution of Radio Applications. The |
| | | requirement is described in clause 6.2.1 of |
| | | [1]. |
| | R-FUNC-MDR-03 | The radio configuration of a reconfigurable |
| | | MD shall be realized with the activation of |
| | | Radio Applications (RA) and, if necessary, |
| | | changing parameters of the activated RAs. |
| | | The requirement is described in clause |
| | | 6.4.3 of [1]. |
| Flow Controller | R-FUNC-RAT-05 | If a reconfigurable MD allows parallel |
| | | connections to RATs (in alignment to R- |
| | | FUNC-RAT-01), various independent data |
| | | flows should be maintained |
| | | simultaneously. The requirement is |
| | | described in clause 6.1.5 of [1] |
| | R-FUNC-RA-04 | Radio Applications should support the |
| | | function of transferring receive |
| | | (Rx)/transmit (Tx) data to/from the |
| | | networking stack. The requirement is |
| | | described in clause 6.2.4 of [1] |
| Multiradio Controller | R-FUNC-RAT-01 | A reconfigurable MD should support |
| | | parallel connections to more than one |
| | | Radio Access Technology. The |
| | | requirement is described in clause 6.1.1 of |
| | | [1] |
| | R-FUNC-RAT-02 | If a reconfigurable MD allows parallel |
| | | connections to RATs, (in alignment to R- |
| | | FUNC-RAT-01), in-device coexistence |
| | | functionalities shall be implemented. The |
| | | requirement is described in clause 6.1.2 of |
| | | [1] |
| | R-FUNC-RAT-03 | If a reconfigurable MD allows parallel |
| | | connections to RATs (in alignment to R- |
| | | FUNC-RAT-01), seamless handover of |
| | | data streams from one RAT to another |
| | | RAT should be implemented. The |
| | | requirement is described in clause 6.1.3 of |
| | | [1] |
| | R-FUNC-RAT-06 | If a reconfigurable MD allows parallel |
| | | connections to RATs (in alignment to R- |
| | | FUNC-RAT-01), Link Adaptation |
| | | techniques across multiple RATs should be |
| | | implemented. The requirement is described |
| | | in clause 6.1.6 of [1] |
| | R-FUNC-MDR-03 | The radio configuration of a reconfigurable |
| | | MD shall be realized with the activation of |
| | | Radio Applications (RA) and, if necessary, |
| | | changing parameters of the activated RAs. |
| | | The requirement is described in clause |
| | | 6.4.3 of [1] |
| Resource Manager | R-FUNC-RAT-06 | If a reconfigurable MD allows parallel |
| | | connections to RATs (in alignment to R- |
| | | FUNC-RAT-01). Link adaptation |
| | | techniques across multiple RATs should be |
| | | implemented. The requirement is described |
| | | in clause 6.1.6 of [1]. |
| | R-FUNC-MDR-05 | The reconfiguration MD shall support |
| | | dynamic execution of functional blocks. |
| | | The requirement is described in clause |
| | | 6.4.5 of [1]. |
| Radio Connection Manager | R-FUNC-RAT-04 | If policies are applied to a reconfigurable |
| | | MD, the link selection functionality in the |
| | | reconfigurable MD shall meet the related |
| | | conditions. The requirement is described in |
| | | clause 6.1.4 of [1]. |
| | R-FUNC-RAT-05 | If a reconfigurable MD allows parallel |
| | | connections to RATs (in alignment to R- |
| | | FUNC-RAT-01), various independent data |
| | | flows should be maintained |
| | | simultaneously. The requirement is |
| | | described in clause 6.1.5 of [1]. |
| | R-FUNC-RAT-06 | If a reconfigurable MD allows parallel |
| | | connections to RATs (in alignment to R- |
| | | FUNC-RAT-01), Link Adaptation |
| | | techniques across multiple RATs should be |
| | | implemented. The requirement is described |
| | | in clause 6.1.6 of [1]. |
| | R-FUNC-RA-03 | Reconfigurable MDs should support |
| | | concurrent execution of Radio |
| | | Applications. The requirement is described |
| | | in clause 6.2.3 of [1]. |
| | R-FUNC-MDR-03 | The radio configuration of a reconfigurable |
| | | MD shall be realized with the activation of |
| | | Radio Applications (RA) and, if necessary, |
| | | changing parameters of the activated RAs. |
| | | The requirement is described in clause |
| | | 6.4.3 of [1]. |

That is, as shown in Table 1, in the case that the flow controller as an entity, component or unit supports the system requirement R-FUNC-RAT-05, the reconfigurable mobile device incorporating such the flow controller may allow parallel connections to radio access technologies (RATs) in alignment to R-FUNC-RAT-01, thereby simultaneously maintaining several independent data flows.

In the case that the flow controller as an entity, component or unit supports the system requirement R-FUNC-RAT-04, the reconfigurable mobile device incorporating such the flow controller may support a function of transferring receive (Rx) data or transmit (Tx) data to or from the network stack.

In the case that the multiradio controller as an entity, component or unit supports the system requirement R-FUNC-RAT-01, the reconfigurable mobile device incorporating such the multiradio controller may support parallel connections to one or more radio access technologies.

In the case that the multiradio controller as an entity, component or unit supports the system requirement R-FUNC-RAT-02, the reconfigurable mobile device incorporating such the multiradio controller, when parallel connections to radio access technologies are allowed, may implement in-device coexistence functionalities within the device in alignment to R-FUNC-RAT-01.

In the case that the multiradio controller as an entity, component, or unit supports the system requirement R-FUNC-RAT-03, the reconfigurable mobile device incorporating such the multiradio controller, when parallel connects to radio access technologies are allowed, may implement seamless handover of data streams from one RAT to another RAT in alignment to R-FUNC-RAT-01.

In the case that the multiradio controller as an entity, component or unit supports the system requirement R-FUNC-RAT-06, the reconfigurable mobile device incorporating such the multiradio controller, when parallel connections to radio access technologies are allowed, may implement link adaptation techniques across multiple radio access technologies in alignment to R-FUNC-RAT-01.

In the case that the multiradio controller as an entity, component or unit supports the system requirement R-FUNC-MDR-03, the reconfigurable mobile device incorporating such the multiradio controller may implement activation of radio applications in radio configuration and, if necessary, change parameters of the activated radio applications.

In the case that the radio connection manager as an entity, component or unit supports the system requirement R-FUNC-RAT-04, the reconfigurable mobile device incorporating such the radio connection manager may allow link selection functionality to meet related conditions through application of policies.

In the case that the radio connection manager as an entity, component or unit supports the system requirement R-FUNC-RAT-05, the reconfigurable mobile device incorporating such the radio connection manager, when parallel connections to radio access technologies are allowed, may maintain various independent data flows simultaneously in alignment to R-FUNC-RAT-01.

In the case that the radio connection manager as an entity, component or unit supports the system requirement R-FUNC-RAT-06, the reconfigurable mobile device incorporating such the radio connection manager, when parallel connections to radio access technologies are allowed, may implement link adaptation techniques across multiple RATs in alignment to R-FUNC-RAT-01.

In the case that the radio connection manager as an entity, component or unit supports the system requirement R-FUNC-RA-03, the reconfigurable mobile device incorporating such the radio connection manager may support concurrent execution of radio applications.

In the case that the radio connection manager as an entity, component or unit supports the system requirement R-FUNC-MDR-03, the reconfigurable mobile device incorporating such the radio connection manager may implement activation of radio applications and, if necessary, change parameters of the activated radio applications.

The above-described definition of the system requirements may be found in the European Telecommunications Standards Institute (ETSI) EN 303 905 document.

In Table 1, R-FUNC-RAT represents a functional requirement on radio access technology. The configuration of the radio application may be performed by the configuration manager. Also, the management of the parameters may be performed by the configuration manager.

Also, among the radio application requirements, R-FUNC-RA-05 may support a function of transmitting context information. This may be associated with a predetermined interface (e.g., an interface CII).

According to the present embodiment, the appropriate requirements of the URAI may be link-adapted.

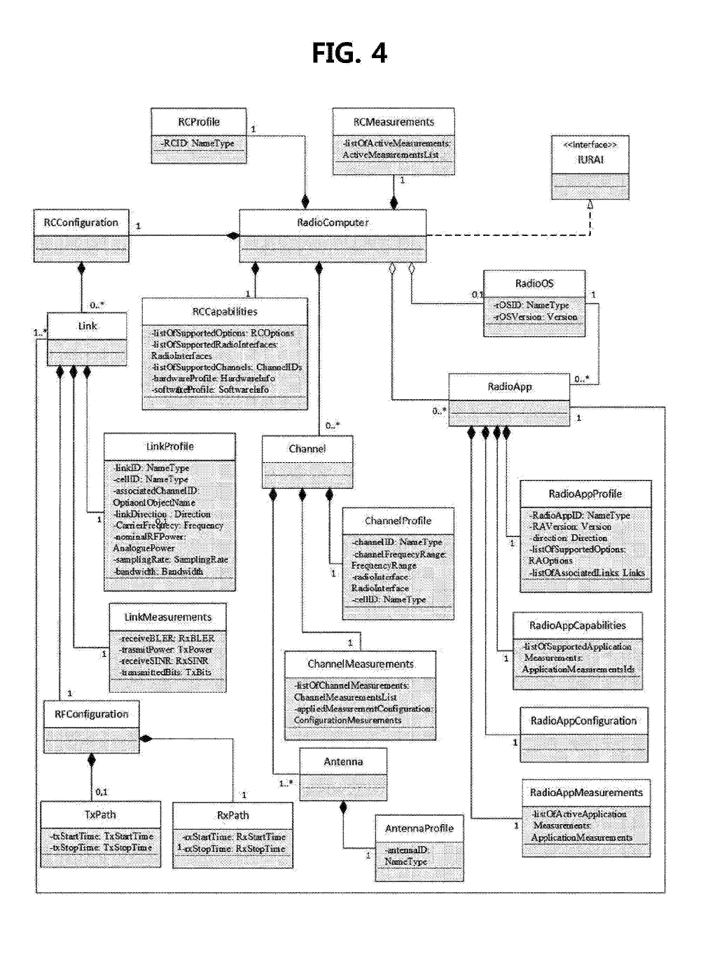

FIG. 4 is a UML class diagram of a radio computer class associated with a URAI according to an embodiment of the present invention.

As shown in FIG. 4, the information model of the radio computer related to the URAI in the mobile device according to the present embodiment may be defined by the following radio computer classes.

RCUser class may describe information related to the user of the radio computer. Each instance of the RCUser class depends on one instance of a RadioComputer class.

RadioComputer class may include all unified radio application-related information about resources and interactions associated with the hardware and software of the reconfigurable mobile device. All the unified radio application-related information includes, for example, computational/spectral resource usage, collection of context information, channel measurement results, etc.

RadioOS class may describe an installed radio OS. Each instance of the RadioComputer class may relate to zero or one instance of the RadioOS class. Each instance of the RadioOS class is associated with zero or several instances of a RadioApp class.

RadioApp class may describe one currently active radio application. Each instance of the RadioComputer class may relate to zero or several instances of the RadioApp class. Each instance of the RadioApp class is associated with one instance of the RadioOS class. Also, each instance of the RadioApp class is associated with zero, one or many instances of a Link class.

RadioAppProfile class may include general information about the radio application, for example, radio application ID, current version of radio application, direction (downlink or uplink), links used to deliver this radio application, etc. Each instance of the RadioApp class may have only one instance of the RadioAppProfile class as a member.

RadioAppCapabilities class may include information about measurements supported by the radio application, for example, delay, loss, and bandwidth measurements. Each instance of the RadioApp class may have only one instance of the RadioAppCapabilities class as a member.

RadioAppMeasurements class may include measurements performed by the radio application, for example, delay, loss, and bandwidth measurements. Each instance of the RadioApp class may have only one instance of the RadioAppMeasurements class as a member. Multiple measurements may be contained within the instance of the class.

RCProfile class may include general information about the radio computer, for example, terminal identification. Each instance of the RadioComputer class may have only one instance of the RCProfile class as a member.

RCMeasurements class may include current measurements (instantaneous measurement data and related metadata) related to the reconfigurable mobile device such as battery capacity, user mobility, mobile device location determination, and connection history information. Each instance of the RadioComputer class may have only one instance of the RCMeasurements class as a member.

RCCapabilities class may include information about radio computer capabilities including hardware, software, transmission and measurement capabilities such as supported RATs and maximum transmission power. Each instance of the RadioComputer class may have only one instance of the RCCapabilities class as a member.

Channel class may include one radio channel that may or may not be used by an active radio link. Each instance of the RadioComputer class may have zero, one or several instances of the Channel class as members. In case of an active radio link, at least one of the Channel class may be available.

ChannelProfile class may include general information about the radio channel such as channel ID, center frequency, bandwidth, and used RAT. Each instance of the Channel class may have only one instance of the Channel Profile class as a member.

ChannelMeasurements class may include current measurements (instantaneous measurement data and related metadata) and the applied measurement configuration related to the radio channel such as interference and load measurements. Each instance of the Channel class may have only one instance of the ChannelMeasurements class as a member.

Antenna class may include information about antenna selection. Each instance of the Channel class may have at least one instance of the Antenna class as a member.

AntennaProfile class may include general information about the antenna, such as antenna port, applicable frequency range and antenna gain. Each instance of the Antenna class may have only one instance of the AntennaProfile class as a member.

RCConfiguration class may include information about the current configuration of radio computer. Each instance of the RadioComputer class may have only one instance of the RCConfiguration class as a member.

Link class may include information about one active unified radio application and the corresponding connection between the reconfigurable mobile device and a radio access network (RAN). Each instance of the RCConfiguration class may have zero, one or several instances of the Link class as members. Each instance of the Link class is associated with one instance of the RadioApp class.

LinkProfile class may include general information about the active connection, for example, link identification (ID), serving cell ID, channel used, etc. Each instance of the Link class may have only one instance of the LinkProfile class as a member.

LinkMeasurements class may include current measurements (instantaneous measurement data and related metadata) related to the active connection, such as block error rate (BLER), power, and signal to interference plus noise ratio (SINR) measurements. Each instance of the Link class may have only one instance of the LinkMeasurements class as a member.

RFConfiguration class may include information about configuration of a RF transceiver. Each instance of the Link class may have only one instance of the RFConfiguration class as a member.

TxPath class may include information about one transmit path. Each instance of the RFConfiguration class may zero or one instance of the TxPath class as a member.

RxPath class may include information about one receive path. Each instance of the RFConfiguration class may have only one instance of the RxPath class as a member.

The Channel Class described above may be separate from the Link Class, but the channel measurements may be based on any mobile device configuration which may or may not be used for a final link configuration.

The class definitions for the information model of the radio computer related to the URAI described above may be summarized as in the following Tables 2 to 22.

TABLE 2
Class RadioComputer
This class contains all URA related information about resources and
interactions related to hardware and software of a reconfigurable MD.

DERIVED FROM

ATTRIBUTES

| | |
|---|---|
| CONTAINED IN | |
| CONTAINS | RCCapabilities [1], RCConfiguration [1], |
| | RCMeasurements [1], Channel [*], RCProfile [1], |
| | RadioAPP [*], RadioOS [0-1] |
| SUPPORTED | |
| EVENTS | |

TABLE 3
Class RadioOS
This class describes installed Radio OS.

DERIVED FROM

ATTRIBUTES

| | | | |
|---|---|---|---|
| rOSID | Value type: | Possible access: | Default value: |
| | NameType | Read | Not specified |

This attribute describes ID of Radio OS.

| | | | |
|---|---|---|---|
| rOS Version | Value type: | Possible access: | Default value: |
| | Version | Read | Not specified |

This attribute describes a version of Radio OS.

| | |
|---|---|
| CONTAINED IN | RadioComputer |
| CONTAINS | |
| SUPPORTED | |
| EVENTS | |

TABLE 4
Class RadioApp
This class describes installed Radio Application.

DERIVED FROM

ATTRIBUTES
This attribute contains a list of supported options.

| | |
|---|---|
| CONTAINED IN | RadioComputer |
| CONTAINS | RadioAppProfile [1], RadioAppCapabilities [1], |
| | RadioAppMeasurements [1] |
| SUPPORTED | |
| EVENTS | |

TABLE 5
Class RadioAppProfile
This class contains general information about the Radio Application.

DERIVED FROM

ATTRIBUTES

| | | | |
|---|---|---|---|
| RadioAppID | Value type: | Possible | Default value: |
| | Name Type | access: | Not specified |
| | | Read | |

This attribute describes ID of installed Radio Application.

| | | | |
|---|---|---|---|
| RAVersion | Value type: | Possible | Default value: |
| | Version | access: | Not specified |
| | | Read | |

This attribute describes a version of Radio Application.

| | | | |
|---|---|---|---|
| direction | Value type: | Possible | Default value: |
| | Direction | access: | Not specified |
| | | Read | |

This attribute describes whether this Radio Application is downlink or
uplink application or both.

| | | | |
|---|---|---|---|
| listOfSupportedOptions | Value type: | Possible | Default value: |
| | RAOptionsList | access: | Not specified |
| | | Read | |

This attribute contains a list of supported options (i.e. optional
features as defined in related standard versus mandatory features).

| | | | |
|---|---|---|---|
| listOfAssociatedLinks | Value type: | Possible | Default value: |
| | Links | access: | Not specified |
| | | Read | |

This attribute describes list of IDs of links used to transmit user data.

| | |
|---|---|
| CONTAINED IN | RadioApp |
| CONTAINS | |
| SUPPORTED | |
| EVENTS | |

TABLE 6
Class RadioAppCapabilities
This class contains information about measurements supported by this
Radio Application.

DERIVED FROM

ATTRIBUTES

| | | | |
|---|---|---|---|
| listOfSupported- | Value type: | Possible | Default value: |
| ApplicationCapabilities | Application- | access: | Not specified |
| | MeasurementsIds | Read | |

This attribute describes capabilities supported by this Radio Application.

| | |
|---|---|
| CONTAINED IN | RadioApp |
| CONTAINS | |
| SUPPORTED | |
| EVENTS | |

TABLE 7
Class RadioAppMeasurements
This class contains measurements performed by this Radio Application.

DERIVED FROM

ATTRIBUTES

| | | | |
|---|---|---|---|
| listOfActive- | Value type: | Possible | Default value: |
| Application- | Application- | access: | Not specified |
| Measurements | Measurements | Read-Add- | |
| | | Remove | |

This attribute describes measurements that are currently performed by
the Radio Application.

| | | | |
|---|---|---|---|
| requestOfContext- | Value type: | Possible | Default value: |
| Informations | Context- | access: | Not specified |
| | InformationInfo | Read | |

This attribute describes context information that are requested by other
entity such as Monitor. There can be a request for one-time delivery, a
request for cyclic delivery or request for conditional delivery.

| | |
|---|---|
| CONTAINED IN | RadioApp |
| CONTAINS | |
| SUPPORTED | |
| EVENTS | |

TABLE 8
Class RCProfile
This class contains general information about the Radio Computer.

DERIVED FROM

ATTRIBUTES

| | | | |
|---|---|---|---|
| RCID | Value type: | Possible access: | Default value: |
| | Name Type | Read | Not specified |

This attribute describes ID of radio computer.

| | |
|---|---|
| CONTAINED IN | RadioComputer |
| CONTAINS | |
| SUPPORTED | |
| EVENTS | |

TABLE 9
Class RCMeasurements
This class contains current measurements related to Reconfigurable Radio
terminal.

DERIVED FROM

ATTRIBUTES

| | | | |
|---|---|---|---|
| listOfActive- | Value type: | Possible | Default value: |
| Measurements | ActiveMeasure- | access: | Not specified |
| | mentsList | Read-Add- | |
| | | Remove | |

This attribute describes a list of active measurements.

| | |
|---|---|
| CONTAINED IN | RadioComputer |
| CONTAINS | |
| SUPPORTED | |
| EVENTS | |

TABLE 10
Class RCCapabilities
This class contains information about Radio Computer capabilities
including hardware, software, transmission and measurement capabilities.

DERIVED FROM

ATTRIBUTES

| | | | |
|---|---|---|---|
| listOfSupportedOptions | Value type: | Possible | Default |
| | RCOptionsList | access: | value: |
| | | Read-Write | Not |
| | | | specified |

This attribute describes a list of supported options.

| | | | |
|---|---|---|---|
| listOfSupported- | Value type: | Possible | Default |
| RadioInterfaces | RadioInterfacesList | access: | value: |
| | | Read-Write | Not |
| | | | specified |

This attribute describes radio interfaces supported by this Radio Computer.

| | | | |
|---|---|---|---|
| listOfSupportedChannels | Value type: | Possible | Default |
| | ChannelIDsList | access: | value: |
| | | Read-Write | Not |
| | | | specified |

This attributes describes frequency channels supported by this Radio
Computer.

| | | | |
|---|---|---|---|
| hardwareProfile | Value type: | Possible | Default |
| | HardwareInfo | access: | value: |
| | | Read-Write | Not |
| | | | specified |

This attributes describes hardware capabilities of this Radio Computer.

| | | | |
|---|---|---|---|
| softwareProfile | Value type: | Possible | Default |
| | SoftwareInfo | access: | value: |
| | | Read-Write | Not |
| | | | specified |

This attributes describes software capabilities of this Radio Computer.

| | |
|---|---|
| CONTAINED IN | RadioComputer |
| CONTAINS | |
| SUPPORTED EVENTS | |

TABLE 11
Class Channel
This class describes one frequency channel that may or may not have
active connections on it.
DERIVED FROM
ATTRIBUTES

| | |
|---|---|
| CONTAINED IN | RadioComputer |
| CONTAINS | ChannelProfile [1], ChannelMeasurements [1], |
| | Antenna [+] |
| SUPPORTED | |
| EVENTS | |

TABLE 12
Class ChannelProfile
This class contains general information about this frequency channel.
DERIVED FROM
ATTRIBUTES

| | | | |
|---|---|---|---|
| channelID | Value type: | Possible access: | Default value: |
| | Name Type | Read | Not specified |

This attribute describes ID of channel.

| | | | |
|---|---|---|---|
| channelFrequencyRange | Value type: | Possible access: | Default value: |
| | FrequencyRange | Read | Not specified |

This attribute describes a value of channel frequency range.

| | | | |
|---|---|---|---|
| radioInterface | Value type: | Possible access: | Default value: |
| | RadioInterface | Read | Not specified |

This attribute describes a radio interface.

| | | | |
|---|---|---|---|
| cellID | Value type: | Possible access: | Default value: |
| | Name Type | Read | Not specified |

This attribute describes ID of connected cell.

| | |
|---|---|
| CONTAINED IN | Channel |
| CONTAINS | |
| SUPPORTED | |
| EVENTS | |

TABLE 13
Class ChannelMeasurements
This class contains current measurements related to this frequency channel.
DERIVED FROM
ATTRIBUTES

| | | | |
|---|---|---|---|
| listOfChannelMeasurements | Value type: | Possible access: | Default value: |
| | ChannelMeasurementsList | Read | Not specified |

This attribute describes a list of channel measurements.

| | | | |
|---|---|---|---|
| appliedMeasurementsConfiguration | Value type: | Possible access: | Default value: |
| | ConfigurationMeasurements | Read | Not specified |

This attribute describes configuration option of the MD, e.g. which Antenna(s) have
been used, which RF front-end(s) have been used, etc.

| | |
|---|---|
| CONTAINED IN | Channel |
| CONTAINS | |
| SUPPORTED | |
| EVENTS | |

TABLE 14

| Class Antenna | |
|---|---|
| This class contains information about antenna selection. | |
| DERIVED FROM | |
| ATTRIBUTES | |
| CONTAINED IN | Channel |
| CONTAINS | AntennaProfile [1] |
| SUPPORTED | |
| EVENTS | |

TABLE 15
Class AntennaProfile
This class contains general information about this antenna.
DERIVED FROM
ATTRIBUTES

| | | | |
|---|---|---|---|
| antennaID | Value type: | Possible access: | Default value: |
| | Name Type | Read | Not specified |

This attribute describes ID of antenna.

| | |
|---|---|
| CONTAINED IN | Antenna |
| CONTAINS | |
| SUPPORTED | |
| EVENTS | |

TABLE 16

| Class RCConfiguration | |
|---|---|
| This class contains information about the current configuration of | |
| Radio Computer. | |
| DERIVED FROM | |
| ATTRIBUTES | |
| CONTAINED IN | RadioComputer |
| CONTAINS | Link [*] |
| SUPPORTED | |
| EVENTS | |

TABLE 17
Class Link
This class contains information about one active Radio Application and
corresponding connection between Reconfigurable Radio terminal and
RANs.
DERIVED FROM
ATTRIBUTES

| | |
|---|---|
| CONTAINED IN | RCConfiguration |
| CONTAINS | LinkProfile [1], LinkMeasurements [1], |
| | RFConfiguration [1] |
| SUPPORTED | |
| EVENTS | |

TABLE 18
Class LinkProfile
This class contains general information about this active connection.
DERIVED FROM
ATTRIBUTES

| | | | |
|---|---|---|---|
| linkID | Value type: | Possible access: | Default value: |
| | Name Type | Read | Not specified |

This attribute describes ID of link about activated connection.

| | | | |
|---|---|---|---|
| cellID | Value type: | Possible access: | Default value: |
| | Name Type | Read-Write | Not specified |

This attribute describes ID connected cell.

| | | | |
|---|---|---|---|
| associatedChannelID | Value type: | Possible access: | Default value: |
| | OptionalObjectName | Read-Add-Remove | Not specified |

This attribute describes ID of associated channel.

| | | | |
|---|---|---|---|
| linkDirection | Value type: | Possible access: | Default value: |
| | Direction | Read | Not specified |

This attribute describes a direction of link.

| | | | |
|---|---|---|---|
| carrierFrequency | Value type: | Possible access: | Default value: |
| | FrequencyRange | Read-Write | Not specified |

This attribute describes a value of carrier frequency.

| | | | |
|---|---|---|---|
| nominalRFPower | Value type: | Possible access: | Default value: |
| | AnaloguePower | Read | Not specified |

This attribute describes a value of nominal power.

| | | | |
|---|---|---|---|
| samplingRate | Value type: | Possible access: | Default value: |
| | SamplingRate | Read-Write | Not specified |

This attribute describes a value of sampling rate.

| | | | |
|---|---|---|---|
| Bandwidth | Value type: | Possible access: | Default value: |
| | Bandwidth | Read-Write | Not specified |

This attribute describes a value of bandwidth.

| | |
|---|---|
| CONTAINED IN | Link |
| CONTAINS | |
| SUPPORTED | |
| EVENTS | |

TABLE 19
Class LinkMeasurements
This class contains current measurements related to this active connection.
DERIVED FROM
ATTRIBUTES

| | | | |
|---|---|---|---|
| receiveBLER | Value type: | Possible access: | Default value: |
| | RxBLER | Read-Write | Not specified |

This attribute describes a value of BLER for received data.

| | | | |
|---|---|---|---|
| transmitPower | Value type: | Possible access: | Default value: |
| | TxPower | Read-Write | Not specified |

This attribute describes a power of transmit signal.

| | | | |
|---|---|---|---|
| receiveSINR | Value type: | Possible access: | Default value: |
| | RxSINR | Read-Write | Not specified |

This attribute describes a value of SINR for received data.

| | | | |
|---|---|---|---|
| transmittedBits | Value type: | Possible access: | Default value: |
| | TxBits | Read-Write | Not specified |

This attribute describes transmitted bits.

| | |
|---|---|
| CONTAINED IN | Link |
| CONTAINS | |
| SUPPORTED | |
| EVENTS | |

TABLE 20
Class RFConfiguration
This class contains information about the configuration of RF transceiver.
DERIVED FROM
ATTRIBUTES

| | |
|---|---|
| CONTAINED IN | Link |
| CONTAINS | TxPath [0-1], RxPath [1] |
| SUPPORTED | |
| EVENTS | |

TABLE 21
Class TxPath
This class describes one transmit path.

| DERIVED FROM | DERIVED FROM | | |
|---|---|---|---|
| ATTRIBUTES | | | |
| txStartTime | Value type: | Possible | Default value: |
| | TxStartTime | access: | Not specified |
| | | Read-Write | |

This attribute defines the time when the transceiver start transmission.

| | | | |
|---|---|---|---|
| txStopTime | Value type: | Possible | Default value: |
| | TxStopTime | access: | Not specified |
| | | Read-Write | |

This attribute defines the time when the transceiver stop transmission.

| | |
|---|---|
| CONTAINED IN | RFConfiguration |
| CONTAINS | |
| SUPPORTED | |
| EVENTS | |

TABLE 22
Class RxPath
This class describes one receive path.

| DERIVED FROM | DERIVED FROM | | |
|---|---|---|---|
| ATTRIBUTES | | | |
| rxStartTime | Value type: | Possible | Default value: |
| | RxStartTime | access: | Not specified |
| | | Read-Write | |

This attribute defines the time when the transceiver start reception.

| | | | |
|---|---|---|---|
| rxStopTime | Value type: | Possible | Default value: |
| | RxStopTime | access: | Not specified |
| | | Read-Write | |

This attribute defines the time when the transceiver stop reception.

| | |
|---|---|
| CONTAINED IN | RFConfiguration |
| CONTAINS | |
| SUPPORTED | |
| EVENTS | |

Interface Definition

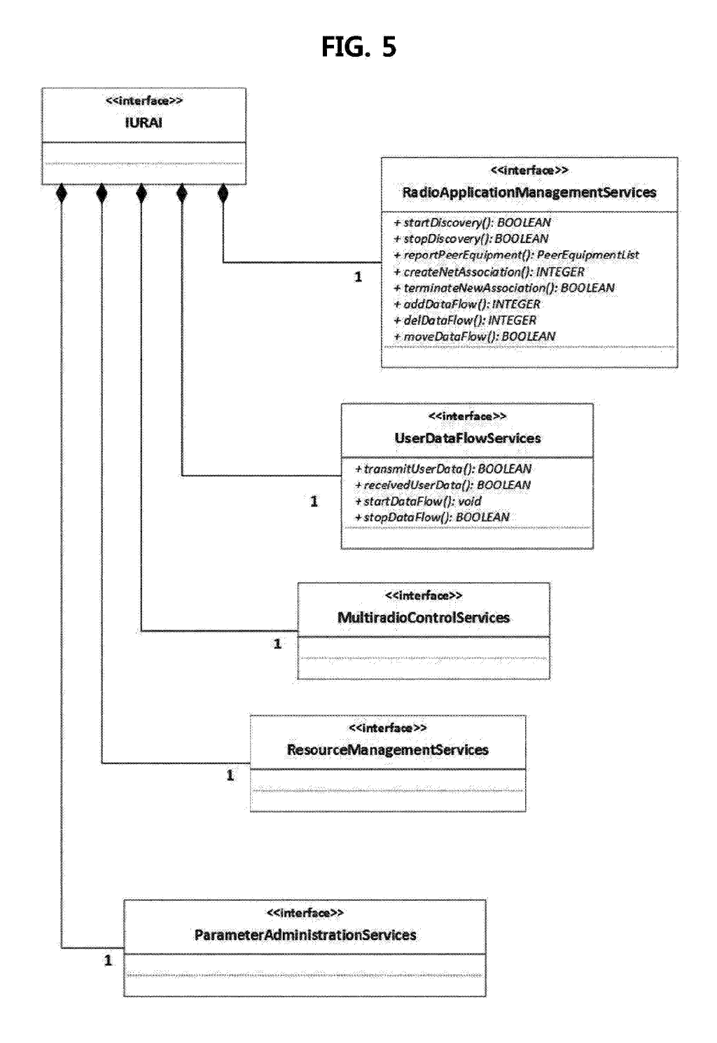

Hereinafter, the interface definition of the URAI described above with reference to FIG. 5 is as follows. FIG. 5 is a UML diagram of three services applicable to the URAI of FIG. 4.

Referring to FIG. 5, the URAI according to the present embodiment supports three basic services. The basic services may include radio application management services, user data flow services, and multi-radio control services.

The basic services of the URAI will be described in detail as follows.

Radio Application Management Services

The radio application management service may be associated with the operation of the radio connection manager of the radio control framework. That is, the class definition and associated operations of the radio application management service may be subject to certain operational procedures between the components of the radio control framework and the unified radio application in the reconfigurable mobile device. In the operational procedures, one or more procedures may be associated with an identified reference point.

More specifically, the radio application management service (hereinafter referred to as ‘RAMS’) may install and activate a radio application through the configuration manager (CM) and the radio connection manager (RCM). Also, the RAMS may operate the radio application to discover peer equipment(s) in the mobile device. The discovery of peer equipment(s) may be performed independently of software reconfiguration technology through the use of integrated circuits. The RAMS may then inform the radio connection manager of the states of the peer equipment(s).

Also, the RAMS may report the discovered peer equipment(s). For such services, the unified radio application (URA) may report to the radio connection manager about the accessible peer equipment discovered during the discovery procedure. When the reconfigurable mobile device is requested as peer equipment by another mobile device, the requesting mobile device may be included in the accessible peer equipment.

Also, the RAMS may create or terminate association with the peer equipment. For this service, the radio connection manager may request the unified radio application to create or terminate association with the accessible peer equipment.

Also, the RAMS may start or stop transmission or reception of user data. In this service, among the activated and associated unified radio applications, the radio connection manager may request some selected unified radio applications to perform actual transmission or reception of user data.

Messages of the radio application management service (RAMS) may be as follows. Among the URAI, the RAMS interfaces may be used to transmit the following messages.

In other words, from the radio control framework (RCF) to the unified radio application (URA), the interfaces of the RAMS may be used for requesting to start or stop the discovery of the peer equipment, requesting to create or terminate the association with the peer equipment, or requesting to start or stop communications with the peer equipment.

Also, from the unified radio application (URA) to the radio control framework (RCF), the interfaces of the RAMS may be used to transmit or receive messages for confirmation of the creation of the association, confirmation of the termination of the association, confirmation of starting communications with the peer equipment, confirmation of stopping communications with the peer equipment, failure of the creation of the association, failure of the termination of the association, failure of starting communications with the peer equipment, failure of stopping communications with the peer equipment, or information about discovered peer equipments.

User Data Flow Services

The user data flow services may be associated with the operation of the flow controller of the radio control framework. That is, the class definition and associated operations of the user data flow services may be subject to certain operational procedure between the components of the radio control framework and the unified radio application in the reconfigurable mobile device. In the operational procedures, one or more procedures may be associated with an identified reference point.

More specifically, the user data flow services may include a data flow control service. The data flow control service may be implemented to accommodate some collisions in a data flow between a sender and a receiver in transmitting or receiving user data. In this service, the unified radio application may request the flow controller to change the configuration of the data flow.

Messages of the user data flow services may be as follows. That is, the interfaces of the user data flow services may be used to transmit the following messages.

From the radio control framework (RCF) to the unified radio application (URA), the interfaces of the user data flow services may be used for requesting to transfer user data.

Also, from the unified radio application (URA) to the radio control framework (RCF), the interfaces of the user data flow services may be used to transmit or receive messages for requesting to change data flow configuration, requesting to transfer information related to the unified radio application, confirmation of transferring user data, failure of transferring user data, and information about user data.

Multiradio Control Services

The multiradio control services may be associated with the operation of the multiradio controller of the radio control framework. That is, the class definition and associated operations of the multiradio control services may be subject to certain operating procedures between the components of the radio control framework and the unified radio application in the reconfigurable mobile device. In the operational procedures, one or more procedures may be associated with an identified reference point.

More specifically, the multiradio control services may be used to synchronize radio time. In this service, the multiradio controller may request all the activated unified radio applications to operate with a unified synchronism.

Messages of the multiradio control services may be as follows. That is, the interfaces of the multiradio control services may be used for requesting synchronization of radio time, from the radio control framework (RCF) to the unified radio application (URA). Also, from the unified radio application (URA) to the radio control framework (RCF), the interfaces of the multiradio control services may be used for transmit or receive messages for confirmation of synchronization of radio time, or failure of synchronization of radio time.

The class definitions for the three services of the URAI described above may be shown in the following Tables 23 to 25.

TABLE 23
Class RadioApplicationManagementServices
This class describes interfaces supporting Radio Application
Management Services.
OPERATIONS

| | | |
|---|---|---|
| reprotPeerEquipment | Return type: | Value type: |
| | PeerEquipmentList | public |

This operation is needed for getting the list of discovered Peer
Equipments.

| | | |
|---|---|---|
| createNetAssociation | Return type: | Value type: |
| | INTEGER | public |

This operation is needed for creating an association with Peer Equipment.

| | | |
|---|---|---|
| terminateNetAssociation | Return type: | Value type: |
| | BOOLEAN | public |

This operation is needed for terminating an association.

| | | |
|---|---|---|
| startTransmission | Return type: | Value type: |
| | BOOLEAN | public |

This operation is needed for starting user data transmission with
Peer Equipment.

| | | |
|---|---|---|
| stopTransmission | Return type: | Value type: |
| | BOOLEAN | public |

This operation is needed for stopping user data transmission with
Peer Equipment.

| | | |
|---|---|---|
| startReception | Return type: | Value type: |
| | BOOLEAN | public |

This operation is needed for starting user data reception.

| | | |
|---|---|---|
| stopReception | Return type: | Value type: |
| | BOOLEAN | public |

This operation is needed for stopping user data reception.

TABLE 24

| Class UserDataFlowServices | | |
|---|---|---|
| This class describes interfaces supporting User data Flow Services. | | |
| OPERATIONS | | |
| requestChangeofDataflow | Return type: | Value type: |
| | BOOLEAN | public |
| This operation is needed for requesting change of data flow. | | |
| sendtoURA | Return type: | Value type: |
| | UserData | public |
| This operation is needed for sending user data to URA. | | |
| receivefromURA | Return type: | Value type: |
| | UserData | public |

This operation is needed for receiving user data from URA.

TABLE 25
Class MultiradioControlServices
This class describes interfaces supporting Multiradio Control Services.
OPERATIONS

| | | |
|---|---|---|
| syncRadioTime | Return type: | Value type: |
| | BOOLEAN | public |

This operation is needed for synchronizing radio time.

The following is an example of abstract data definitions used in data attribute definition of the mobile device. All necessary abstract data definitions may be included in a given module of the mobile device. The definitions of these abstract data are shown in Tables 26 to 29 below.

TABLE 26
------------------------------------------------------------------
------------------------------------------------------------------
-- START Common Data Types
------------------------------------------------------------------
-- START Name Related Data Types

| | |
|---|---|
| NameType | ::= CHOICE { |

| | |
|---|---|
| number | INTEGER, |
| string | PrintableString |

| | |
|---|---|
| } | |
| ObjectName | ::= SEQUENCE OF NameType |

| | |
|---|---|
| OptionalObjectName | ::= CHOICE { |

| | |
|---|---|
| id | ObjectName, |
| void | NULL |
| } | |

| | |
|---|---|
| ObjectNameList | ::= SEQUENCE OF ObjectName |

-- END Name Related Data Types
------------------------------------------------------------------
------------------------------------------------------------------
-- START Version Related Data Types

| | |
|---|---|
| Version | ::= CHOICE { |

| | |
|---|---|
| intVersion | INTEGER, |
| stringVersion | PrintableString |

}
-- END Version Related Data Types
------------------------------------------------------------------
-- END Common Data Types
------------------------------------------------------------------
------------------------------------------------------------------
------------------------------------------------------------------
------------------------------------------------------------------
-- START Radio Application Related Data Types

| | |
|---|---|
| RAOptionID | ::= ENUMERATED { |

1to5Mhz,1to10Mhz, 1to20Mhz, ...

| | |
|---|---|
| } | |
| RAOptionsList | ::= SEQUENCE OF SEQUENCE { |

| | |
|---|---|
| rAOptionName | RAOptionID, |
| rAOptionValue | ANY |

| | |
|---|---|
| } | |
| RAMeasurementsID | ::= ENUMERATED { |

| | observedDelay, observedDelayVariation, observedFactatLoss, | |
|---|---|---|
| | observedBandwidth, ... | |
| } | | |
| ApplicationMeasurements | | ::= SEQUENCE OF SEQUENCE { |
| | rAMeasurementsName | RAMeasurementsID, |
| | rAMeasurementsValue | ANY |

}
-- END Radio Application Related Data Types
------------------------------------------------------------------
------------------------------------------------------------------
------------------------------------------------------------------
------------------------------------------------------------------
-- START Radio Computer Related Data Types

| | |
|---|---|
| RadioApplicationIDList | ::= SEQUENCE OF OptionalObjectName |

TABLE 27

| | |
|---|---|
| RCOptionID | ::= ENUMERATED { |

mdrc-0, mdrc-1, mdrc-2, maximumTxPower, ...
}

| | |
|---|---|
| RCOptionsList | ::= SEQUENCE OF SEQUENCE { |

| | |
|---|---|
| rCOptionName | RCOptionID, |
| rCOptionValue | ANY |
| } | |
| RadioInterfaceID | ::= ENUMERATED { |

units, hadpa, wimax, lto, wifi, gam, ...
}

| | |
|---|---|
| RadioInterface | ::= CHOICE { |

| | |
|---|---|
| id | RadioInterfaceID, |
| void | NULL |
| } | |

| | |
|---|---|
| RadioInterfaceList | ::= SEQUENCE OF RadioInterfaceID |

| | |
|---|---|
| ChannelIDsList | ::= SEQUENCE OF OptionalObjectName |
| HardwareInfo | ::= ENUMERATED { |

fixedPipeline, programmablePipeline, hybridPipeline, ...
}

| | |
|---|---|
| SoftwareInfo | ::= ENUMERATED { |

rOSVersion, compiler, ...
}

| | |
|---|---|
| Direction | ::= ENUMERATED { |

downlink, uplink
}

| | |
|---|---|
| RxBLER | ::= SEQUENCE { |

| | |
|---|---|
| accBLER | REAL, |
| period | REAL OPTIONAL, |
| instBLER | REAL OPTIONAL |
| } | |

| | |
|---|---|
| TxPower | ::= SEQUENCE { |

| | |
|---|---|
| power | REAL, |
| unit | CHARACTER |
| } | |

| | |
|---|---|
| RxSINR | ::= SEQUENCE { |

| | |
|---|---|
| accSINR | REAL, |
| period | REAL OPTIONAL, |
| instSINR | REAL OPTIONAL |
| } | |

| | |
|---|---|
| Links | ::= SEQUENCE OF OptionalObjectName |
| TxBits | ::= SEQUENCE { |

| | |
|---|---|
| transmittedBit | REAL, |
| unit | CHARACTER |
| } | |

ActiveMeasurementID ::= ENUMERATED {
transmitPower, transportLoad, processingLoad, ...
}

| | |
|---|---|
| ActiveMeasurementIDs | ::= SEQUENCE OF { |
| activeMeasurementID | |
| } | |

ActiveMeasurementsList ::= SEQUENCE OF SEQUENCE {

| | |
|---|---|
| activeMeasurementName | ActiveMeasurementID, |
| activeMeasurementValue | ANY |
| } | |

TABLE 28

| | |
|---|---|
| FrequencyRange | ::= SEQUENCE { |

| | |
|---|---|
| controlFrequency | REAL, |
| frequencyBand | REAL |
| } | |

| | |
|---|---|
| AnaloguePower | ::= SEQUENCE { |

| | |
|---|---|
| power | REAL, |
| unit | CHARACTER |
| } | |

| | |
|---|---|
| SamplingRate | ::= SEQUENCE { |

| | |
|---|---|
| samplingRate | REAL, |

| | |
|---|---|
| unit | CHARACTER |
| } | |
| Bandwidth | ::= SEQUENCE { |

| | |
|---|---|
| bandwidth | REAL, |

| | |
|---|---|
| unit | CHARACTERs |
| } | |

| | |
|---|---|
| TxStartTime | ::= CHOICE { |
| absoluteTime | GeneralisedTime, |
| relativeTime | INTEGER |
| } | |
| TxStopTime | ::= CHOICE { |
| Undefined | NULL, |
| absoluteTime | GeneralisedTime, |
| relativeTime | INTEGER |
| } | |
| RxStartTime | ::= CHOICE { |
| absoluteTime | GeneralisedTime, |
| relativeTime | INTEGER |
| } | |
| RxStopTime | ::= CHOICE { |
| Undefined | NULL, |
| absoluteTime | GeneralisedTime, |
| relativeTime | INTEGER |
| } | |

| | |
|---|---|
| ChannelMeasurementID | ::= ENUMERATED { |

channelInterference, channelLoad, ...
}

| | |
|---|---|
| ChannelMeasurementsList | ::= SEQUENCE OF SEQUENCE { |

| | |
|---|---|
| channelMeasurementName | ChannelMeasurementID, |
| ChannelMeasurementValue | ANY |
| } | |
| ConfigurationMeasurements::= | ENUMERATED { |

```
    antonnaProt, RFfrontend, ...
}
-- END Radio Computer Related Data Types
------------------------------------------------------------------
------------------------------------------------------------------
------------------------------------------------------------------
------------------------------------------------------------------
-- START Unified Radio Application Interface Related Data Types
RadioAppParameterID ::= ENUMERATED {
    A, b, c, ...
}
```

| | |
|---|---|
| RadioAppParameters | ::= SEQUENCE OF SEQUENCE { |

| | |
|---|---|
| radioAppParameterName | RadioAppParameterID, |
| radioAppParameterValue | ANY |

TABLE 29

| | |
|---|---|
| } | |
| RadioAppsList | ::= SEQUENCE OF SEQUENCE { |

| | |
|---|---|
| RadioAppID | INTEGER, |
| RadioAppName | PrintableString |
| } | |
| RadioMeasurementID | ::= ENUMERATED { |
| A, B, C, ... | |
| } | |
| RadioMeasurementsList | ::= SEQUENCE OF SEQUENCE { |

| | |
|---|---|
| radioMeasurementName | RadioMeasurementID, |
| radioMeasurement | Value ANY |
| } | |

| | |
|---|---|
| PoorEquipmentId | ::= SEQUENCE OF OptionalObjectName |
| PoorEquipmentList | ::= SEQUENCE OF { |
| PoorEquipmentId | |
| } | |

| | |
|---|---|
| UserData | ::= SEQUENCE OF { |

| | |
|---|---|
| userDataID | INTEGER, |
| userDataValue | OBJECT |
| } | |

-- END Unified Radio Application Interface Related Data Types
------------------------------------------------------------------
------------------------------------------------------------------

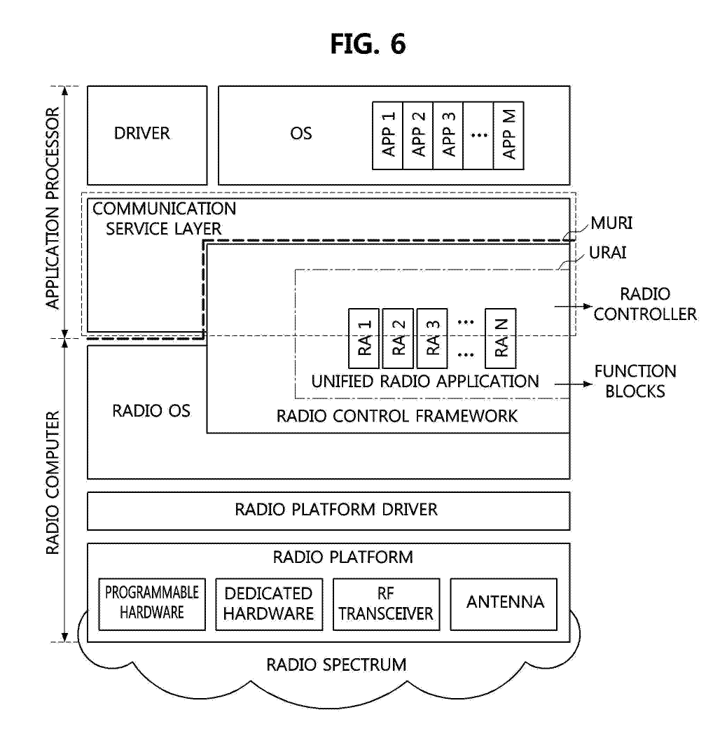

FIG. 6 is a block diagram for explaining a reconfigurable mobile device according to another embodiment of the present invention.

Referring to FIG. 6, a radio software architecture of a reconfigurable mobile device according to the present embodiment may comprise an application processor layer which operates on an application processor (AP) and a radio computer layer which operates on a radio computer. Here, the radio computer may include the radio operating system, the radio platform driver, and the radio platform.

That is, a RCF may have a software architecture environment in which the RCF is divided into two parts—a part being executed on the AP and a part being executed on the radio computer, and executed on the two processors. Of course, the RCF may be implemented to operate on the radio operating system.

A non-real time OS such as Andriod OS of Google, iOS of Apple, etc. may operate on the AP, and a real time OS (hereinafter, referred to as a ‘radio OS’) may operate on the radio computer. Hereinafter, for clear discrimination, the non-real time OS operating on the Application processor layer may be referred to as ‘OS’, and the real time OS operating on the radio computer layer may be referred to as ‘radio OS’.

Hereinafter, the Application processor layer, the radio computer layer, and components constituting the RCF will be described in detail.

Application Processor

The AP comprises, as shown in FIG. 2, the following components such as drivers, an OS, and a communication service layer (CSL).

Drivers may drive hardware devices on a given OS. The hardware devices may include a camera, a speaker, etc.

OS may be a non-real time OS such as Android and iOS operating in general mobile devices. If the RCF is configured to operate on the AP and the RP both, an Application processor layer part of the RCF may exist on the OS.

The CSL may provide at least some of the following three services to the RCF.

The first service is related to an administrative. It may be a service related to installation/uninstallation of radio applications, creating/deleting instance of radio applications, and acquisition of a list of radio applications in each status (installed, instanced, activated).

The second service is related to connection control. It may be a service related to activation/deactivation of radio applications, creation of data flow, creation of network allocation, and acquisition of a list of radio applications in each status (installed, instanced, activated).

The third service is related to data flow. That is, this service is a service related to sending/receiving user data.

As an example of CSL configurations for providing at least some of the above-described three services, the CSL may be configured to comprise an administrator application, a mobility policy manager application, a networking stack, and a monitor application. The networking stack may comprise a protocol stack operating in the CSL.

Meanwhile, the CSL may comprise only some of the above-described components, and may further comprise additional components as well as the above-described components. Also, one or more components among the above components may be integrated into a single component existing within the CSL. Also, the above-described components are only examples of components which the CSL can comprise in order to support services which should be performed by the CSL. That is, the CSL may be defined based on functions performed by it. The above-described exemplary composition of components does not restrict composition of the CSL.

In the configuration in which the RCF operates on both the AP and the RP, radio applications, which become targets of distribution, installation, and execution of the terminal device according to the present embodiment, may respectively comprise Application processor layer parts and RP layer parts. A radio controller (RC) which is the Application processor layer part of each radio application may be configured to transmit context information to the monitor application of the CSL, transmit data to the networking stack of the CSL, and receive data from the networking stack.

Radio Computer

The radio computer may comprise the following components such as the radio OS, radio platform drivers, etc.

The radio OS is a real time operation system. When the RCF is configured to operate on both of the AP and the radio computer, the radio computer layer execution part of the RCF may exist on the radio OS.

The radio platform drivers may be components demanded for the radio OS to recognize a hardware radio platform similarly to usual hardware drivers.

The reconfigurable radio applications that are subject to distribution, installation and execution in the reconfigurable mobile device according to the present embodiment may operate in the radio computer layer.

Radio controllers (RCs) of respective radio applications may be configured to transmit context information to the monitor application of the CSL, transmit data to the networking stack of the CSL, and receive data from the networking stack.

The above-described radio platform may comprise a variety of radio platform hardware. The radio platform hardware may usually comprise programmable hardware and baseband accelerators of the radio computer. The baseband accelerators prepared for the standard function block(s) may usually be provided in form of application-specific integrated circuit (ASIC). Also, the radio platform may include at least one RF transceiver and at least one antenna A radio application is an application enabling communications of a mobile terminal, and may be distributed in form of a radio application package (RAP). The RAP may comprise components such as function blocks (FBs), pipeline configuration metadata, radio controller code (RC code), and radio library.

The radio library may be distributed in form of executable codes as included in a RAP, in a case that the standard function blocks (SFB) are distributed as executable codes. The RAP may be downloaded onto the OS of the AP, and the user-defined function block codes and the radio library may be loaded from the AP to the radio computer by referring to the pipeline configuration metadata, and finally loaded to the radio OS on the radio computer.

Meanwhile, in the present embodiment, the components of the URAI may be functional blocks or modules mounted on a mobile terminal or a computer device, but are not limited thereto. The above-described components may be stored in a computer-readable medium (recording medium) in the form of software for implementing a series of functions that they perform, or may be transmitted to a remote location in the form of a carrier so as to operate on various computer devices. The computer readable medium may be disposed in a plurality of computer devices or a cloud system connected via a network, and at least one of a plurality of computer devices or a cloud system may store a program or source codes, etc. for implementing the URAI of the present embodiment in its memory system.

That is, the computer-readable medium may be embodied in the form of a program command, a data file, a data structure, or the like, alone or in combination. Programs recorded on the computer-readable medium may include those specifically designed and constructed for the present invention or those known and available to those skilled in the computer software.

Also, the computer-readable medium may include a hardware device specifically configured to store and execute program instructions, such as a ROM, a RAM, a flash memory, and the like. The program instructions may include machine language codes such as those generated by a compiler, as well as high-level language codes that may be executed by a computer using an interpreter or the like. The hardware device may be configured to operate with at least one software module to implement the interface of the present embodiment, and vice versa.

Also, the program instructions may be executed by a processor mounted on the mobile terminal. The processor may include one or more cores and a cache memory. When the processor has a multi-core structure, a multi-core may refer to integrating two or more independent cores into a single package of a single integrated circuit. When the processor has a single core architecture, the processor may be referred to as a central processing unit. The central processing unit (CPU) may be implemented as a system on chip (SOC) in which a micro control unit (MCU) and peripheral devices (integrated circuits for external expansion devices) are disposed together. The core includes registers for storing instructions to be processed, arithmetic logical units (ALUs) for comparisons, judgments, and arithmetic operations, internal control units (CPUs) for internally controlling CPUs for interpreting and executing instructions a control unit, an internal bus, and the like.

The above-described processor may include, but is not limited to, one or more data processors, image processors, or codecs. The data processor, image processor, or codec may be configured separately. The processor may further include a peripheral device interface and a memory interface. The peripheral device interface connects the processor to the input/output device and/or other peripheral devices, and the memory interface connects the processor and the memory. The above-described processor may execute a specific software module (instruction set) stored in the memory to perform various specific functions corresponding to the module.

While embodiments of the present disclosure and their advantages have been described in detail above, it should be understood that various changes, substitutions and alterations may be made herein without departing from the scope of the disclosure.

1. An operation method of a reconfigurable mobile device using a unified radio application interface (URAI), the operation method comprising:
providing a radio control framework (RCF) operating on a radio computer of the mobile device and a unified radio application (URA) operating on the radio computer with at least one service among radio application management services, user data flow services, and multiradio control services of the URAI; and
communicating, by the RCF, with the URA through the URAI, and reconfiguring a radio application according to a radio communication environment or a radio access environment of the mobile device.

2. The operation method according to claim 1, wherein the radio application management services include, from the RCF to the URA, a service of requesting report of discovered peer equipment, a service of requesting creation or termination of association with the peer equipment, a service of requesting start or stop of communications with the peer equipment, or a service of a combination thereof.

3. The operation method according to claim 2, wherein the radio application management services include, from the URA to the RCF, a service of confirming the creation of association with the peer equipment, a service of confirming the termination of association with the peer equipment, a service of confirming the start of communications with the peer equipment, a service of confirming the stop of communications with the peer equipment, a service of notifying a failure of the creation of association with the peer equipment, a service of notifying a failure of the termination of association with the peer equipment, a service of notifying a failure of the start of communications with the peer equipment, a service of notifying a failure of the stop of communications with the peer equipment, a service of transmitting or receiving information, state information, or messages about the peer equipment, or a service of a combination thereof.

4. The operation method according to claim 3, wherein the radio application management services support a radio connection manager of the RCF to install a radio application and activate the installed radio application.

5. The operation method according to claim 4, wherein the radio application management services support the URA to inform the radio connection manager about accessible peer equipment discovered during a discovery procedure.

6. The operation method according to claim 1, wherein the user data flow services support the RCF to request the URA to transfer user data.

7. The operation method according to claim 6, wherein the user data flow services include, from the URA to the RCF, a service of requesting to change data flow configuration, a service of transferring information related to the URA, a service of confirmation of transferring user data, a service of responding a failure of transferring user data, a service of transmitting a confirmation message or a response to transferred user data, or a service of a combination thereof.

8. The operation method according to claim 1, wherein the user data flow services support the URA to request a flow controller of the RCF to change data flow configuration.

9. The operation method according to claim 1, wherein the multiradio control services support the RCF to request radio time synchronization to the URA.

10. The operation method according to claim 9, wherein the multiradio control services support the URA to transfer a message for confirming the radio time synchronization or notifying a failure of the radio time synchronization to the RCF.

11. A reconfigurable mobile device comprising:
a radio platform including a radio frequency (RF) transceiver as a part of hardware of the mobile device;
a radio control framework (RCF) which is a part of a radio operating system operating on the radio platform;
a unified radio application (URA) installed on the radio operating system and managed by the RCF; and
a unified radio application interface (URAI) which provides, between the RCF and the URA, at least one service of radio application management services, user data flow services, and multiradio control services to the RCF and the URA.

12. The reconfigurable mobile device according to claim 11, wherein the URAI provides, from the RCF to the URA through the radio application management services, a service of requesting report of discovered peer equipment, a service of requesting creation or termination of association with the peer equipment, a service of requesting start or stop of communications with the peer equipment, or a service of a combination thereof.

13. The reconfigurable mobile device according to claim 12, wherein the URAI provides, from the URA to the RCF through the radio application management services, a service of confirming the creation of association with the peer equipment, a service of confirming the termination of association with the peer equipment, a service of confirming the start of communications with the peer equipment, a service of confirming the stop of communications with the peer equipment, a service of notifying a failure of the creation of association with the peer equipment, a service of notifying a failure of the termination of association with the peer equipment, a service of notifying a failure of the start of communications with the peer equipment, a service of notifying a failure of the stop of communications with the peer equipment, a service of transmitting or receiving information, state information, or messages about the peer equipment, or a service of a combination thereof.

14. The reconfigurable mobile device according to claim 11, wherein the URAI supports, through the radio application management services, a radio connection manager of the RCF to install a radio application in the radio operating system and activate the installed radio application.

15. The reconfigurable mobile device according to claim 14, wherein the URAI supports, through the radio application management services, the URA to inform the radio connection manager about accessible peer equipment discovered during a discovery procedure.

16. The reconfigurable mobile device according to claim 11, wherein the URAI supports, through the user data flow services, the RCF to request the URA to transfer user data.

17. The reconfigurable mobile device according to claim 16, wherein the URAI provides, from the URA to the RCF through the user data flow services, a service of requesting to change data flow configuration, a service of transferring information related to the URA, confirmation of transferring user data, a service of responding a failure of transferring user data, a service of transmitting a confirmation message or a response to transferred user data, or a service of a combination thereof.

18. The reconfigurable mobile device according to claim 11, wherein the URAI supports, through the user data flow services, the URA to request a flow controller of the RCF to change data flow configuration.

19. The reconfigurable mobile device according to claim 11, wherein the URAI supports the RCF to request radio time synchronization to the URA through the multiradio control services, and support the RCF to receive a message for confirming the radio time synchronization or notifying a failure of the radio time synchronization from the URA through the multiradio control services.
